(19) United States
(12) Patent Application Publication
(10) Pub. No.: US 2025/0081079 A1
(43) Pub. Date: Mar. 6, 2025

(54) Adaptive Dynamic Link Selection

(71) Applicant: Apple Inc., Cupertino, CA (US)

(72) Inventors: Aimin J. Sang, Santa Clara, CA (US); Ehsan Haghani, Redwood City, CA (US); Faraz Faheem, Santa Clara, CA (US); Erdogan Dede, San Diego, CA (US)

(21) Appl. No.: 18/461,202

(22) Filed: Sep. 5, 2023

(51) Int. Cl. H04W 40/12

(52) U.S. Cl. CPC H04W 40/12

(57) ABSTRACT

Apparatuses, systems, and methods for adaptive dynamic radio link selection, e.g., in 5G NR systems and beyond. A UE may select two or more performance values for a first communication link (e.g., an uplink, downlink, and/or sidelink communication link) selected from a plurality of communication links for performance monitoring of the first communication link. The performance values (e.g., such as an agreed performance value, a measured performance, and/or a predicted performance value) may be associated with one or more performance metrics configured for the performance monitoring. The UE may monitor the performance values for the first communication link for performance degradation and select, in response to detecting a performance degradation, a second communication link for performance comparison to the first communication link. The UE may trigger link changes (e.g., link switching and/or link aggregation) based on the performance comparison of the second communication link to the first communication link.

### FIELD

The invention relates to wireless communications, and more particularly to apparatuses, systems, and methods for adaptive dynamic radio link selection, e.g., in cellular systems, such as 5G New Radio (NR) systems and beyond.

### DESCRIPTION OF THE RELATED ART

Wireless communication systems are rapidly growing in usage. In recent years, wireless devices such as smart phones, wearable devices or accessory devices), and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for adaptive dynamic radio link selection, e.g., in 5G NR systems, LTE systems, WiFi systems and beyond.

For example, in some embodiments, a UE may be configured to select two or more performance values for a first communication link (e.g., an uplink, downlink, and/or sidelink communication link) selected from a plurality of communication links for performance monitoring of the first communication link. The two or more performance values (e.g., such as an agreed performance value, a measured performance, and/or a predicted performance value) may be associated with a performance metric configured for the performance monitoring. Further, the UE may be configured to monitor the two or more performance values for the first communication link for performance degradation. Additionally, the UE may be configured to select, in response to detecting a performance degradation, a second communication link for performance comparison to the first communication link and trigger link changes based on the performance comparison of the second communication link to the first communication link. The link changes may include both link switching and link aggregation.

As another example, in some embodiments, a UE may be configured to select a plurality of performance metrics associated with a first communication link (e.g., an uplink, downlink, and/or sidelink communication link) selected from a plurality of communication links for performance monitoring. Further, for each performance metric of the plurality of performance metrics configured for performance monitoring, the UE may be configured to determine two or more performance values (e.g., such as an agreed performance value, a measured performance, and/or a predicted performance value) associated with a performance metric for the first communication link, monitor the two or more performance values for the first communication link for performance degradation, and select, in response to detecting a performance degradation, an other communication link from the plurality of communication links. The selections may result in a set of candidate communication links. In addition, the UE may be configured to trigger link changes based on the performance comparison of the set of candidate communication links to the first communication link. The comparison may be made among one or more of the performance values regarding one or a plurality of the performance metrics. The link changes may include both link switching and link aggregation.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIG. 8 illustrates a block diagram of an example of a flow for link selection using a single dimension algorithm, according to some embodiments.

FIG. 9 illustrates a block diagram of an example of a flow for link selection using a multiple dimension algorithm, according to some embodiments.

FIG. 10 illustrates a block diagram of an example of a detailed flow for a single-dimensional link selection, according to some embodiments.

FIGS. 11 and 12 illustrate block diagrams of examples of methods for link selection, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element.
MAC: Medium Access Control
SSB: Synchronization Signal Block
CSI: Channel State Information
PDCCH: Physical Downlink Control Channel
PDSCH: Physical Downlink Shared Channel
RRC: Radio Resource Control
RRM: Radio Resource Management
CORESET: Control Resource Set
TCI: Transmission Configuration Information
DCI: Downlink Control Information

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed), though the user may choose to revoke or revise the automatically filled form for accuracy or certain optimization. The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

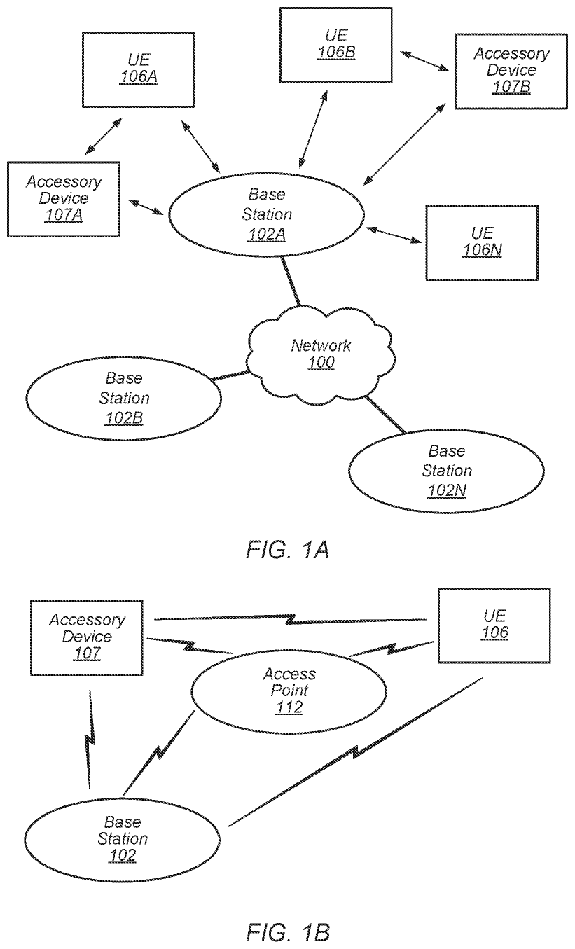

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more wireless devices, such as user devices 106A, 106B, etc., through 106N, as well as accessory devices, such as user devices 107A, 107B. Each of the user devices may be referred to herein as a “user equipment” (UE). Thus, the user devices 106 and 107 are referred to as UEs or UE devices.

The base station (BS) 102A may be a base transceiver station (BTS) or cell site (a “cellular base station”) and may include hardware that enables wireless communication with the UEs 106A through 106N as well as UEs 107A and 107B.

The communication area (or coverage area) of the base station may be referred to as a “cell.” The base station 102A and the UEs 106/107 may be configured to communicate over the transmission medium using any of various radio access technologies (RATs), also referred to as wireless communication technologies, or telecommunication standards, such as, LTE, LTE-Advanced (LTE-A), 5G new radio (5G NR), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106/107 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106/107 as illustrated in FIG. 1, each UE 106/107 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106/107 may be capable of communicating using multiple wireless communication standards. For example, the UE 106/107 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., LTE, LTE-A, 5G NR, etc.). The UE 106/107 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Note that accessory devices 107A/B may include cellular communication capability and hence are able to directly communicate with cellular base station 102A via a cellular RAT. However, since the accessory devices 107A/B are possibly one or more of communication, output power, and/or battery limited, the accessory devices 107A/B may in some instances selectively utilize the UEs 106A/B as a proxy for communication purposes with the base station 102A and hence to the network 100. In other words, the accessory devices 107A/B may selectively use the cellular communication capabilities of its companion device (e.g., UEs 106A/B) to conduct cellular communications. The limitation on communication abilities of the accessory devices 107A/B may be permanent, e.g., due to limitations in output power or the RATs supported, or temporary, e.g., due to conditions such as current battery status, inability to access a network, or poor reception.

FIG. 1B illustrates user equipment 106 (e.g., one of the devices 106A through 106N) and accessory device (or user equipment) 107 (e.g., one of the devices 107A or 107B) in communication with a base station 102 and an access point 112 as well as one another, according to some embodiments. The UEs 106/107 may be devices with both cellular communication capability and non-cellular communication capability (e.g., Bluetooth, Wi-Fi, and so forth) such as a mobile phone, a wearable device, a hand-held device, a computer or a tablet, or virtually any type of wireless device. The accessory device 107 may be a wearable device such as a smart watch. The accessory device 107 may comprise cellular communication capability and be capable of directly communicating with the base station 102 as shown. Note that when the accessory device 107 is configured to directly communicate with the base station, the accessory device may be said to be in “autonomous mode.” In addition, the accessory device 107 may also be capable of communicating with another device (e.g., UE 106), referred to as a proxy device, intermediate device, or companion device, using a short-range communications protocol; for example, the accessory device 107 may according to some embodiments be “paired” with the UE 106, which may include establishing a communication channel and/or a trusted communication relationship with the UE 106. Under some circumstances, the accessory device 107 may use the cellular functionality of this proxy device for communicating cellular voice and/or data with the base station 102. In other words, the accessory device 107 may provide voice and/or data packets intended for the base station 102 over the short-range link to the UE 106, and the UE 106 may use its cellular functionality to transmit (or relay) this voice and/or data to the base station on behalf of the accessory device 107. Similarly, the voice and/or data packets transmitted by the base station and intended for the accessory device 107 may be received by the cellular functionality of the UE 106 and then may be relayed over the short-range link to the accessory device. As noted above, the UE 106 may be a mobile phone, a tablet, or any other type of hand-held device, a media player, a computer, a laptop or virtually any type of wireless device. Note that when the accessory device 107 is configured to indirectly communicate with the base station 102 using the cellular functionality of an intermediate or proxy device, the accessory device may be said to be in “relay mode.”

The UE 106/107 may include a processor that is configured to execute program instructions stored in memory. The UE 106/107 may perform any of the method embodiments described herein by executing such stored instructions. Alternatively, or in addition, the UE 106/107 may include a programmable hardware element such as an FPGA (field-programmable gate array) that is configured to perform any of the method embodiments described herein, or any portion of any of the method embodiments described herein.

The UE 106/107 may include one or more antennas for communicating using one or more wireless communication protocols or technologies. In some embodiments, the UE 106 may be configured to communicate using, for example, LTE/LTE-Advanced or 5G NR using a single shared radio and/or LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106/107 may share one or more parts of a receive and/or transmit chain between multiple wireless communication technologies, such as those discussed above.

In some embodiments, the UE 106/107 may include separate transmit and/or receive chains (e.g., including separate antennas and other radio components) for each wireless communication protocol with which it is configured to communicate. As a further possibility, the UE 106/107 may include one or more radios which are shared between multiple wireless communication protocols, and one or more radios which are used exclusively by a single wireless communication protocol. For example, the UE 106/107 might include a shared radio for communicating using either of LTE or 5G NR (or LTE), and separate radios for communicating using each of Wi-Fi and Bluetooth. Other configurations are also possible.

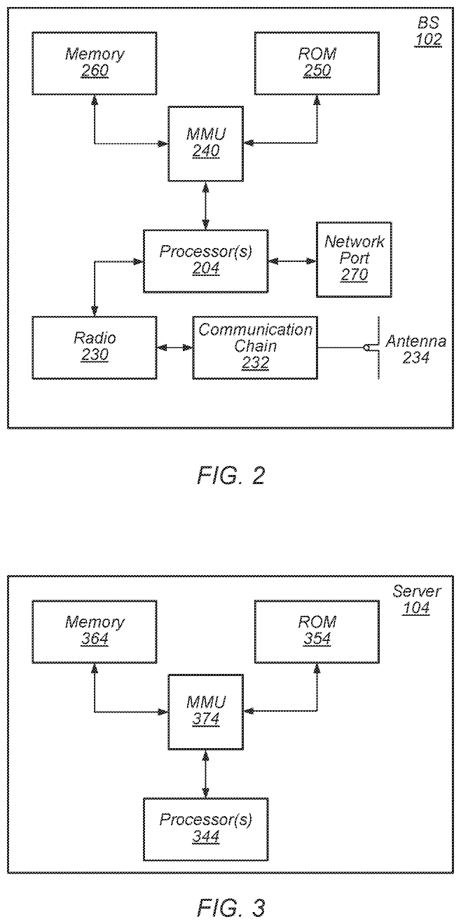

### FIG. 2: Block Diagram of a Base Station

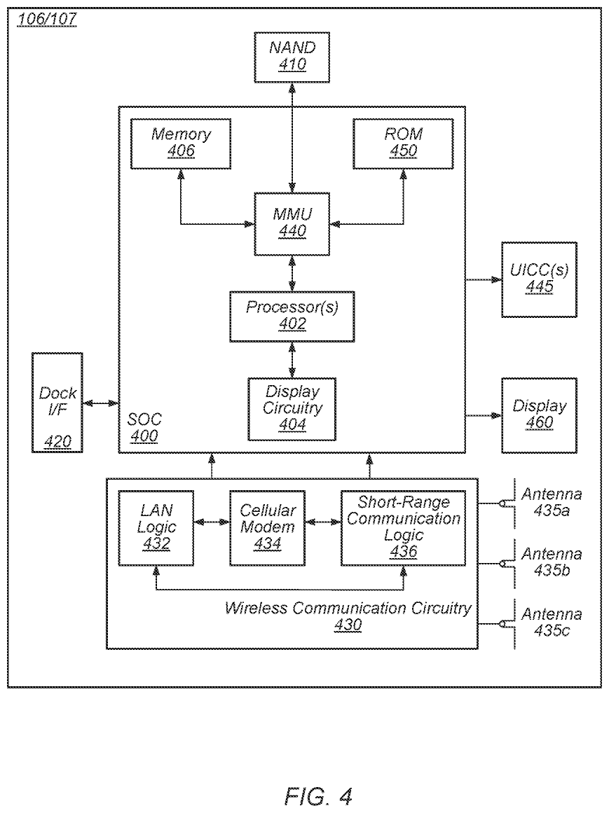

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR. LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

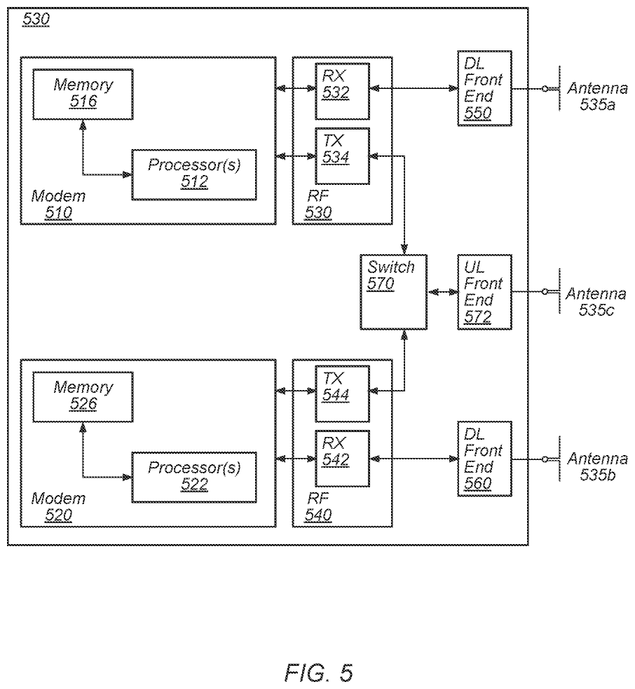

### FIG. 4: Block Diagram of a UE

FIG. 4 illustrates an example simplified block diagram of a communication device 106/107, according to some embodiments. It is noted that the block diagram of the communication device of FIG. 4 is only one example of a possible communication device. According to embodiments, communication device 106/107 may be a user equipment (UE) device, a mobile device or mobile station, a wireless device or wireless station, a desktop computer or computing device, a mobile computing device (e.g., a laptop, notebook, or portable computing device), a wearable device, a tablet, an unmanned aerial vehicle (UAV), a UAV controller (UAC) and/or a combination of devices, among other devices. As shown, the communication device 106/107 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106/107 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106/107, and wireless communication circuitry 430. The wireless communication circuitry 430 may include a cellular modem 434 such as for 5G NR. LTE, LTE-A, etc., and short to medium range wireless communication logic 436 (e.g., Bluetooth™ and WLAN circuitry). In some embodiments, communication device 106/107 may include wired communication circuitry (not shown), such as a network interface card, e.g., for Ethernet.

The wireless communication circuitry 430 may couple (e.g., communicatively; directly or indirectly) to one or more antennas, such as antennas 435a, 435b, and 435c (e.g., 435a-c) as shown. The wireless communication circuitry 430 may include local area network (LAN) logic 432, the cellular modem 434, and/or short-range communication logic 436. The LAN logic 432 may be for enabling the UE device 106/107 to perform LAN communications, such as Wi-Fi communications on an 802.11 network, and/or other WLAN communications. The short-range communication logic 436 may be for enabling the UE device 106/107 to perform communications according to a short-range RAT, such as Bluetooth or UWB communications. In some scenarios, the cellular modem 434 may be a lower power cellular modem capable of performing cellular communication according to one or more cellular communication technologies.

In some embodiments, as further described below, cellular modem 434 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular modem 434 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106/107 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106/107 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106/107 may include at least two SIMs. Each SIM may execute one or more SIM applications and/or otherwise implement SIM functionality. Thus, each SIM may be a single smart card that may be embedded, e.g., may be soldered onto a circuit board in the UE 106/107, or each SIM 410 may be implemented as a removable smart card. Thus, the SIM(s) may be one or more removable smart cards (such as UICC cards, which are sometimes referred to as “SIM cards”), and/or the SIMs 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106/107 may include a combination of removable smart cards and fixed/non-removable smart cards (such as one or more eUICC cards that implement eSIM functionality), as desired. For example, the UE 106/107 may comprise two embedded SIMs, two removable SIMs, or a combination of one embedded SIMs and one removable SIMs. Various other SIM configurations are also contemplated.

As noted above, in some embodiments, the UE 106/107 may include two or more SIMs. The inclusion of two or more SIMs in the UE 106/107 may allow the UE 106/107 to support two different telephone numbers and may allow the UE 106/107 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106/107 comprises two SIMs, the UE 106/107 may support Dual SIM Dual Active (DSDA) functionality. The DSDA functionality may allow the UE 106/107 to be simultaneously connected to two networks (and use two different RATs) at the same time, or to simultaneously maintain two connections supported by two different SIMs using the same or different RATs on the same or different networks. The DSDA functionality may also allow the UE 106/107 to simultaneously receive voice calls or data traffic on either phone number. In certain embodiments the voice call may be a packet switched communication. In other words, the voice call may be received using voice over LTE (VOLTE) technology and/or voice over NR (VONR) technology. In some embodiments, the UE 106/107 may support Dual SIM Dual Standby (DSDS) functionality. The DSDS functionality may allow either of the two SIMs in the UE 106/107 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a cUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for extended (e.g., greater than 10.24 seconds) eDRX inactive operation, e.g., in 5G NR systems and beyond, as further described herein.

As described herein, the communication device 106/107 may include hardware and software components for implementing the above features for a communication device 106/107 to communicate a scheduling profile for power savings to a network. The processor 402 of the communication device 106/107 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

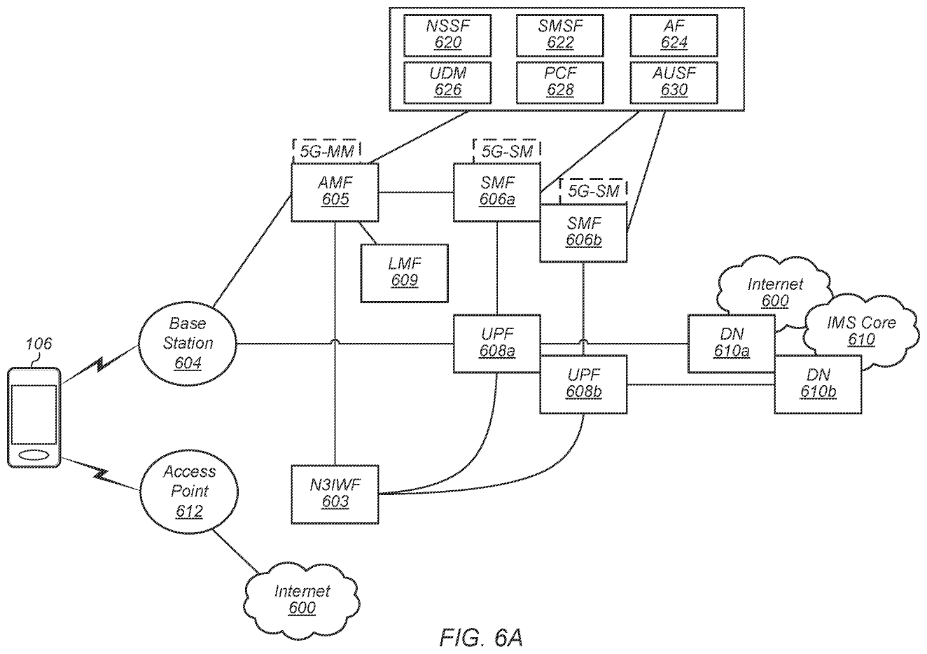

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular modem circuitry 434, may be included in a communication device, such as communication device 106/107 described above. As noted above, communication device 106/107 may be a user equipment (UE) device, a mobile device or mobile station, a wireless device or wireless station, a desktop computer or computing device, a mobile computing device (e.g., a laptop, notebook, or portable computing device), a tablet, a wearable device, and/or a combination of devices, among other devices.

The cellular communication circuitry 530 may couple (e.g., communicatively; directly or indirectly) to one or more antennas, such as antennas 535a-c (which may be antennas 435a-c of FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 535a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 535b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 535c. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for extended (e.g., greater than 10.24 seconds) eDRX inactive operation, e.g., in 5G NR systems and beyond, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 535a-c may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for extended (e.g., greater than 10.24 seconds) eDRX inactive operation, e.g., in 5G NR systems and beyond, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 535a-c may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

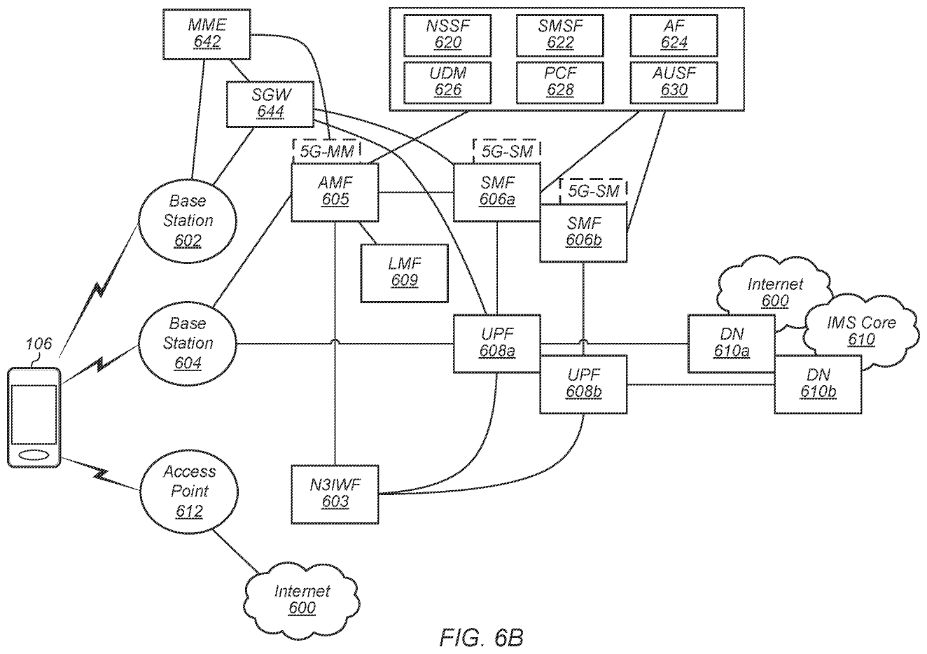

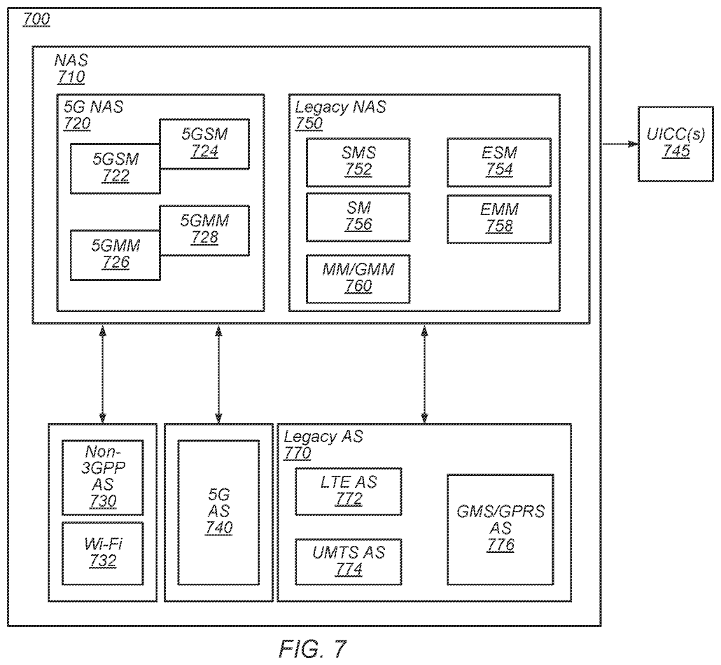

FIGS. 6A, 6B and 7: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may be in communication with an LMF 609 via a networking interface, such as an NLs interface, e.g., as described above, and may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF 606a and the SMF 606b of the 5G CN. The AMF 606 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for extended (e.g., greater than 10.24 seconds) eDRX inactive operation, e.g., in 5G NR systems and beyond, e.g., as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for extended (e.g., greater than 10.24 seconds) eDRX inactive operation, e.g., in 5G NR systems and beyond, e.g., as further described herein.

### Adaptive Dynamic Radio Link Selection

In current implementations, radio link selection algorithms are based on either layer 1 (L1) and/or layer 2 (L2) Quality of Service (QOS) metrics or user-defined static policies (e.g., such as WiFi is considered higher priority than cellular or WiFi is preferred for high-rate data). For example, some current radio link selection algorithms may compare downlink L1/L2 key performance indicator (KPI) metrics (e.g., such as packet loss and/or buffering delay) against static or absolute thresholds to detect congestion (e.g., bottlenecks). As another example, some current radio link selection algorithms may measure radio resource utilization KPIs based on a hypothetically assumed model of a radio link resource allocation by a base station and compare them with thresholds. As a further example, some current radio link selection algorithms may select a “better” radio link based on current radio links' buffer occupancy, static policies, and/or predicted bandwidth occupancy of an alternative radio link at L1/L2.

However, current radio link selection algorithms are known to be unreliable, non-adaptive (static), and/or marginally generalizable. For example, current radio link selection algorithms do not generally consider Quality of Experience (e.g., user perceivable, application-specific performance metrics as direct inputs or performance targets). As another example, L1/L2 and/or lower-layer QoS KPI metrics (used by current radio link selection algorithms) for a UE are often defined to a network operator's benefit and not necessarily honored by carriers. As a further example, low-layer dynamics (e.g., bandwidth occupancy and/or packet losses) often mismatch that of QoEs (e.g., application traffic patterns and/or end-to-end packet losses). Additionally, end-to-end QoE and radio access QoS differ in dynamic cross-layer interactions, e.g., codec adaptation at middle layers (e.g., layer 3 (L3) and/or layer 4 (L4)). In addition, base station-controlled resource scheduling algorithms differ in network operators, in deployment scenarios, and in base station vendor, hence, these can hardly be modelled accurately. Also, UE-measured L1/L2 resource allocation and/or QOS KPIs, e.g., buffer occupancy, vary greatly due to randomness in competing number of UEs or short-term channel variations. Finally, statically defined policies, such as “WiFi preferred over 5G”, cannot scale to general scenarios (e.g., from indoor-outdoor to mobile) or be dynamically adaptively (e.g., for streaming media applications, adopting good yet congested WiFi vs. adopting good 5G signals yet of limited data quota, normally relies on static thresholds). Therefore, improvements are desired.

Embodiments described herein provided systems, methods, and mechanisms for adaptive dynamic radio link selection, including systems, methods and mechanisms for a UE-side algorithm to dynamically, in real-time, select radio link(s) that, once active/activated, offer better performance than current serving link(s). The algorithm may use application-level QoE (Quality of Experience) metrics as real-time KPI inputs as well as major KPI optimization targets. Further, the algorithm may be configured to consider only L1/L2 radio resource allocation, L1˜L3 QOS related KPIs, L3/L4 KPIs (e.g., such as codec rate degradation and/or IP flow-level packet losses), and/or application-layer QoE metrics. In general, the algorithm avoids relying on static configuration of channel (or rate or load) thresholds or hypothetical behaviors of the network-side scheduling.

In some instances, a best active link, as used herein, may refer to a (radio) link that may offer best application-layer UE QoEs and not necessarily best network-defined QoS or resource utilization KPIs. Thus, a link may be selected if, and only if, the link provides comparatively better QoE than a current active link(s) alone (may be subject to cost and resource constraints. Further, a link, as used herein, may refer to a UE-usable cellular radio carrier, a bandwidth part (BWP), an LTE RAT, an NR RAT, a WiFi RAT, a WiFi channel, a WiFi band, a network slice, a flow, a data radio bearer (DRB), a logical channel (LC), a logic channel group (LCG), a Packet Data Unit (PDU), a PDN (Packet Data Network) session, a private network, a public network, and/or any link from a neighboring cell, a neighboring access point, and/or a neighboring network. Note that link and RAT may be used interchangeably herein. Additionally, Quality of Experiences (QoEs), as used herein, may refer to cross-level (OSI Layer 1 to OSI Layer 7 and/or OSI Layer 4 to OSI Layer 7, in particular) measured performance metrics as UE/Application perceivable user experiences in real-time or in history. Note further, that as used herein, QoE may be in alignment with and/or beyond 3GPP-defined QoEs for Multimedia Telephony Service for IMS (MTSI), Mixed Reality, Conversational VOIP, and/or Video Streaming traffic. Further, Quality of Services (QoS), as used herein, may refer to cross-layer performance metric targets as expected by a UE and/or signaled and/or agreed between UE-Network. Note that traditionally, QoE often refers to an application-layer end-to-end (E2E) performance metric (e.g., such as transmission control protocol (TCP) goodput, frame loss rate, Perceptual Objective Listening Quality Analysis (POLQA) score, video stall duration, and/or video stall frequency) most perceivable to a UE as well as to UE-network joint, in contrast to the often network-centric QoSs that refer to performance metrics (e.g., such as minimum rate, bandwidth, and/or protocol data unit (PDU) loss ratio) at L1˜L2 or L3. Hence, QoS may diverge greatly from QoE if protocol overheads (e.g., L1˜L7 encapsulation, protocol-specific packet retransmission, codec rate adaptation, etc.) and/or core network behaviors are not considered.

For example, for high-definition (HD) video streaming, a 20 mega-bits per second (mbps) average throughput may be a good QoS (high rate), but may result in a bad QoE (e.g., due to glitches, severe jitters, or lower goodput). As another example, a large bandwidth link, despite its abundant L1/L2 resources, may not satisfy a UE's QoE requirements due to strong competitions whereas a small bandwidth, but less congested (e.g., as compared to the large bandwidth link) link may satisfy the UE's QoE requirements better. As a further example, for a UE, heavily occupied and/or allocated L1˜L2 resources may imply a potential QoS bottleneck, but may still result in a better serviced QoE.

In some instances, a UE may consider QoE or both QoE and QoS (e.g., per configuration). In some instances, a link selection algorithm (e.g., a Measurement-Expectation Difference Detection (MEDD) based algorithm) may compare the service performance values of experienced quality metrics (e.g., QoE) to that of predicted quality metrics (e.g., QoP), or further to that of signaled quality metrics (e.g., QoS) among links to determine a better/best link for usage. In this manner, the algorithm (e.g., the MEDD based algorithm) may avoid relying on random L1˜L2 radio metrics (e.g., such as real-time scheduling patterns) and network-defined QoS KPIs (e.g., for guaranteed bit rate (GBR) traffic), which are not necessarily consistently honored by carriers. Further, the algorithm (e.g., the MEDD based algorithm) may avoid comparing dynamic performance metrics against static engineering thresholds and/or policies to make a link selection decision.

In some instances, the algorithm (e.g., the MEDD based algorithm) may be scalable in that any dimension(s) of target service metrics are best satisfied iteratively and comparably among candidate links. For a single dimension algorithm (e.g., a single-dimensional MEDD (S-MEDD) based algorithm), each dimension may refer to a specific QoE/QoS metric, e.g., such as goodput, throughput, delay, and/or frame loss, of a specific direction (e.g., uplink or downlink) and for each dimension (e.g., for each QoE/QoS metric), the algorithm may derive candidate links (e.g., a set of candidate links) that may offer better services than current active links (e.g., a set of current active links) for a specific KPI metric. For a multi-dimension algorithm (e.g., a multi-dimensional MEDD (M-MEDD) based algorithm), the single dimension algorithm may scale up via iterations across multiple metrics, where each iteration may focus on one metric among multiple feasible links and the algorithm may derive candidate links (e.g., a set of candidate links) that may offer better service performance values than current active links (e.g., a set of current active links) in terms of all target KPI metrics.

In some instances, the algorithm (e.g., the single dimension and/or the multi-dimension algorithm) may be configured to select a link for addition (e.g., instead of replacing an existing active link, the algorithm may select a link for secondary cell group (SCG) addition and/or component carrier activation), e.g., to offer multiple-link aggregated services. Note that link aggregation may be practical when service-level duplication across multiple links is needed and/or when a single link fails to meet KPI metric targets.

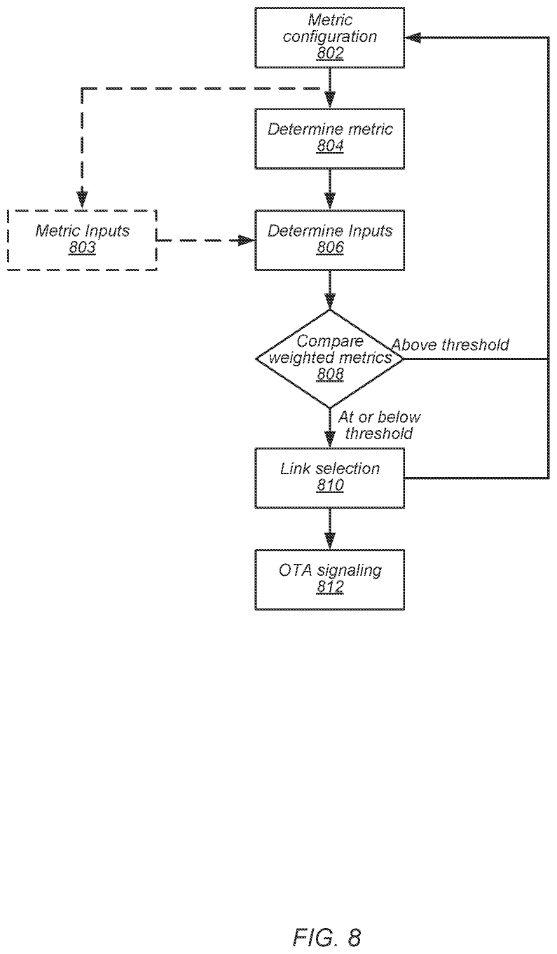

FIG. 8 illustrates a block diagram of an example of a flow for link selection using a single dimension algorithm, according to some embodiments. The example shown in FIG. 8 may be used in conjunction with any of the systems, methods, or devices shown in the Figures, among other devices. In various embodiments, some of the elements shown may be performed concurrently, in a different order than shown, or may be omitted. Additional elements may also be performed as desired. As shown, this example may flow as follows.

At 802, application-level and/or UE/network configuration of performance metrics may be configured. The performance metrics may be considered KPI metrics. The performance metrics may include, among other metrics, average throughput (e.g., expressed as mbps and/or frame rate) for uplink, average throughput (e.g., expressed as mbps and/or frame rate) for downlink, average goodput (e.g., expressed as mbps and/or frame rate) for downlink, average goodput (e.g., expressed as mbps and/or frame rate) for uplink, packet delay for downlink, packet delay for uplink, jitter for downlink, jitter for uplink, queue size for downlink (note this may be at a local proxy server if know to a UE), queue size for uplink, a time-frequency (T-F) allocation in a slot (e.g., expressed as physical resource block (PRB) percentage) for downlink, a time-frequency (T-F) resource allocation in a slot (e.g., expressed as PRB allocation percentage) for uplink, frame loss rate for downlink, frame loss rate for uplink, video stall numbers/count (e.g., receiver frozen over 500 milliseconds), and/or filtered channel quality (e.g., such as reference signal received power (RSRP), signal to interference plus noise ratio (SINR), and so forth). In addition, the performance metrics may be configured based on a signaled value (e.g., a signaled QoS agreement), an observed/measured value (e.g., per experience/measurement), and/or a forecasted value (e.g., a multi-user prediction). Note that the performance metrics may be configured at and/or received from modules at different protocol layers, modules at the application layer, and so forth.

At 803, in some instances (e.g., optionally), other modules (e.g., over-the-air and/or local to the UE) may aid in measuring, deriving, and/or calculating performance metrics and provide these performance metrics as inputs to the algorithm.

At 804, for an active link, a performance metric may be selected. The performance metric may be any of the metrics configured at 802. In addition, a candidate link may be identified. Note that a link may be any of a UE-usable 4G radio carrier, a UE-usable 5F radio carrier, a UE-usable radio carrier, a bandwidth part, an LTE RAT, an NR RAT, a WiFi RAT, a UE-useable RAT, a network slice, any UE-useable RAT and/or radio carrier from a neighboring cell, any UE-useable RAT and/or radio carrier from a neighboring access point, and so forth.

At 806, inputs may be collected, measured, derived, and or calculated. For example, for the active link, the selected performance metric may be calculated/evaluated by measuring a current QoE (and/or obtaining a historical value of QoE), calculated/predicted as a future value (QoP), and/or received/retrieved as a QoS value. Note that QoE, QoP, and QoS may be layer (e.g., protocol layer/application layer) specific.

At 808, for the active link, weighted values of QoP, QoE, and QoS may be compared using the selected performance metric. In instances in which QoP and/or QoE for the selected performance metric exceeds QoS for the active link, the algorithm may return to 804 and another (e.g., a different or the same performance metric) may be selected for evaluation. In instances in which QoP and/or QoE for the selected performance metric does not meet QoS for the active link, the algorithm may continue at 810.

At 810, the (QoP, QoE, or QoS) value of a performance metric for the active link may be compared to that of the same performance metric for the candidate link. For example, with regards to the performance metric, QoE for the active link may be compared to QoS for the active link and QoP for the candidate link. Then, if/when the QoP for the candidate link exceeds QoS for the active link (note QoE has already been determined to not meet QoS for the active link), the candidate link may be selected. As another example, when a QoP for the active link does not meet a QoS for the active link or is shown degrading to below current QoE level of the active link, and a QoP for a candidate link exceeds both the QoE for the active link and a QoS for the candidate link, the candidate link may be selected. Note that if/when link selection is for aggregation instead of switching, the candidate link for aggregation may be added when a QoP for the active link plus a QoP for the candidate link exceeds both a QoE and QoS for the active link.

At 812, the candidate link may be switched to and/or added via over-the-air (OTA) signaling, e.g., with one or more network entities, such as access points, base stations, and the like.

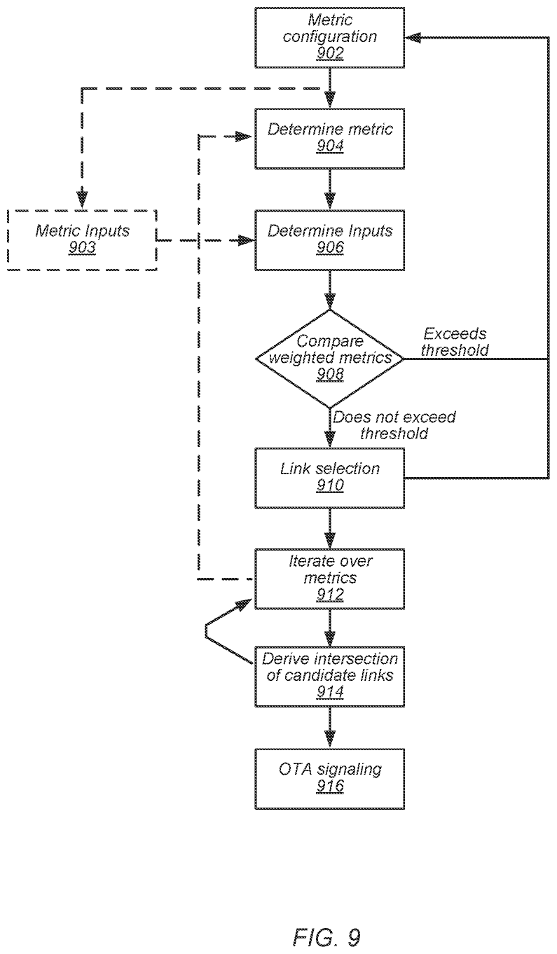

FIG. 9 illustrates a block diagram of an example of a flow for link selection using a multiple dimension algorithm, according to some embodiments. The example shown in FIG. 9 may be used in conjunction with any of the systems, methods, or devices shown in the Figures, among other devices. In various embodiments, some of the elements shown may be performed concurrently, in a different order than shown, or may be omitted. Additional elements may also be performed as desired. As shown, this example may flow as follows.

At 902, application-level and/or UE/network configuration of performance metrics may be configured. The performance metrics may be considered KPI metrics. The performance metrics may include, among other metrics, average throughput (e.g., expressed as mbps and/or frame rate) for uplink, average throughput (e.g., expressed as mbps and/or frame rate) for downlink, average goodput (e.g., expressed as mbps and/or frame rate) for downlink, average goodput (e.g., expressed as mbps and/or frame rate) for uplink, packet delay for downlink, packet delay for uplink, jitter for downlink, jitter for uplink, queue size for downlink (note this may be at a local proxy server if know to a UE), queue size for uplink, a time-frequency (T-F) allocation in a slot (e.g., expressed as physical resource block (PRB) percentage) for downlink, a T-F allocation in a slot (e.g., expressed as PRB percentage) for uplink, frame loss rate for downlink, frame loss rate for uplink, video stall numbers/count (e.g., receiver frozen over 500 milliseconds), and/or filtered channel quality (e.g., such as reference signal received power (RSRP), signal to interference plus noise ratio (SINR), and so forth). In addition, the performance metrics may be configured based on a signaled value (e.g., a signaled QoS agreement), an observed/measured value (e.g., per experience/measurement), and/or a forecasted value (e.g., a multi-user prediction). Note that the performance metrics may be configured at/received from modules at different protocol layers, modules at the application layer, and so forth.

At 903, in some instances (e.g., optionally), other modules (e.g., over-the-air and/or local to the UE) may aid in measuring, deriving, and/or calculating performance metrics and provide these performance metrics as inputs to the algorithm.

At 904, for an active link, a performance metric may be selected. The performance metric may be any of the metrics configured at 802. In addition, a candidate link may be identified. Note that a link may be any of a UE-usable 4G radio carrier, a UE-usable 5F radio carrier, a UE-usable radio carrier, a bandwidth part, an LTE RAT, an NR RAT, a WiFi RAT, a UE-useable RAT, a network slice, a flow, a session, a logical channel, any UE-useable RAT and/or radio carrier from a neighboring cell, any UE-useable RAT and/or radio carrier from a neighboring access point, and so forth.

At 906, inputs may be collected, measured, derived, and or calculated. For example, for the active link, the selected performance metric may be calculated/evaluated by measuring a current QoE (and/or obtaining a historical value of QoE), calculated/predicted as a future value (QoP), and/or received/retrieved as a QoS value.

At 908, for the active link, weighted values of QoP, QoE, and QoS may be compared using the selected performance metric. In instances in which QoP and/or QoE for the selected performance metric exceeds QoS for the active link, the algorithm may return to 804 and an other (e.g., a different or the same performance metric) may be selected for evaluation. In instances in which QoP and/or QoE for the selected performance metric does not meet QoS for the active link, the algorithm may continue at 810.

At 910, the performance metric for the active link may be compared to the performance metric for the candidate link. For example, with regards to the performance metric, QoE for the active link may be compared to QoS for the active link and QoP for the candidate link. Then, if/when the QoP for the candidate link exceeds QoS for the active link (note QoE has already been determined to not meet QoS for the active link), the candidate link may be selected. As another example, when a QoP for the active link does not meet a QoE for the active link and a QoP for a candidate link exceeds both the QoE for the active link and a QoS for the candidate link, the candidate link may be selected. Note that if/when link selection is for aggregation instead of switching, the candidate link for aggregation may be added when a QoP for the active link plus a QoP for the candidate link exceeds both a QoE and QoS for the active link.

At 912, the algorithm may iteratively repeat “link selection” (e.g., elements 904, 906, 908, and 910) for a plurality of performance metrics. For example, the algorithm may consider a first performance metric to determine a first candidate link (e.g., based on the first performance metric), and then repeat the process using one or more additional performance metrics to determine one or more additional candidate links (e.g., based on the one or more additional performance metrics). In this manner, the algorithm may compose and/or develop a set of candidate links.

At 914, the algorithm may determine a candidate link from the set of candidate links, e.g., the algorithm may derive an intersection of the set of candidate links. For example, the algorithm may determine the candidate link based on a first link being selected via the above iteration over multiple performance factors. As another example, the algorithm may determine the candidate link based on a comparison of weighted service improvement for each performance metric. The weighting may be based on a relative importance of each performance metric as assigned by the algorithm. Note that the weighting may be based on a service type of the current link, e.g., weighting based on the relative importance of each performance metric may be associated with and/or based on the service type of the current link.

At 916, the candidate link may be switched to and/or added via over-the-air (OTA) signaling, e.g., with one or more network entities, such as access points, base stations, and the like.

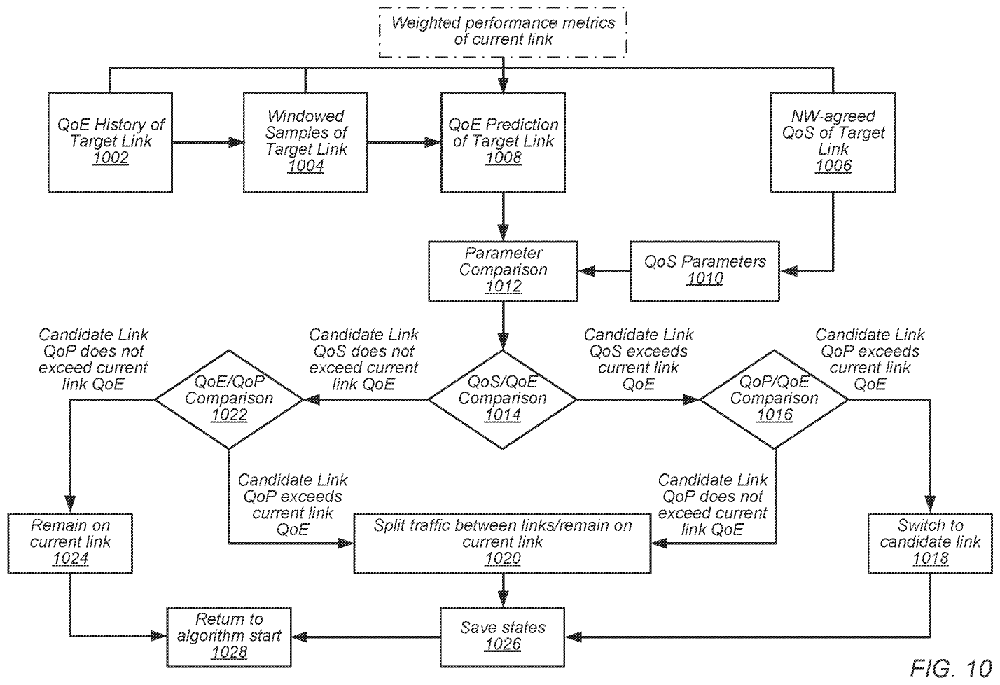

FIG. 10 illustrates a block diagram of an example of a detailed flow for a single-dimensional link selection, according to some embodiments. The example shown in FIG. 10 may be used in conjunction with any of the systems, methods, or devices shown in the Figures, among other devices. In various embodiments, some of the elements shown may be performed concurrently, in a different order than shown, or may be omitted. Additional elements may also be performed as desired. In some embodiments, the example shown in FIG. 10 may be considered a detailed flow of element 810 of FIG. 8 and/or element 910 of FIG. 10. As shown, this example may flow as follows.

At 1002, a QoE history of a performance metric on a target link, j, may be determined, derived, and/or estimated. For example, a history of the performance metric on the target link at a particular protocol layer prior to a time, t, may be determined, derived, and/or estimated.

At 1004, a windowed samples of QoE of the performance metric on the target link may be collected based on a sampling interval, s, for a report and/or filtering window, W. e.g., where the samples include samples at intervals [t−W, t−W+s, t−W+2s, . . . t].

At 1006, a QoS of the performance metric on the target link may be configured at an application-level and/or via UE and/or network configuration.

At 1008, a QoP of the performance metric on the candidate link may be predicted, e.g., based on the windowed samples of QoE of the performance metric on the target link and a QoS of the performance metric on the target link. In other words, a QoP and QoS of the performance metric on the target link may be initialized for comparison to QoE and QoS of the performance metric on a current link.

At 1010, protocol layer QoS of the performance metric may be determined/calculated, and/or derived, e.g., based on the QoS of the performance metric on the target link configured at the application-level and/or via UE/network configuration. In other words, the QoS of the performance metric on the target link configured at the application-level and/or via UE/network configuration may be converted to a protocol layer specific QoS of the performance metric.

At 1012, comparison of the QoP of the performance metric on the target link, the protocol layer specific QoS of the performance metric on the target link, and the QoE of the performance metric on the current link may be initialized.

At 1014, for example, the QoE of the performance metric on the current link may be compared to the protocol layer specific QoS of the performance metric on the target link. Note that when the protocol layer specific QoS of the performance metric on the target link exceeds the QoE of the performance metric on the current link, the algorithm may continue at 1016, otherwise, the algorithm may continue at 1026.

At 1016, when the protocol layer specific QoS of the performance metric on the target link exceeds the QoE of the performance metric on the current link, the QoP of the performance metric on the target link may be compared to the QoE of the performance metric on the current link. Note that when the QoP of the performance metric on the target link exceeds the QoE of the performance metric on the current link, the algorithm may continue at 1018, otherwise the algorithm may continue at 1020.

At 1018, when the QoP of the performance metric on the target link exceeds the QoE of the performance metric on the current link, the algorithm may indicate/recommend a switch to the target link. The algorithm may then continue at 1026.

At 1020, the algorithm may indicate/recommend splitting traffic between the current link and the target link or remaining on the current link. The algorithm may then continue at 1026.

At 1022, when the protocol layer specific QoS of the performance metric on the target link does not exceed the QoE of the performance metric on the current link, the QoP of the performance metric on the target link may be compared to the QoE of the performance metric on the current link. Note that when the QoP of the performance metric on the target link exceeds the QoE of the performance metric on the current link, the algorithm may continue at 1020 as described above, otherwise the algorithm may continue at 1024.

At 1024, the algorithm may indicate/recommend remaining on the current link and the algorithm may continue at 1028.

At 1026, the algorithm may save “states” of the comparisons of the target link to the current link.

At 1028, the algorithm may return to its start, e.g., such as elements 802 of FIG. 8 or 902 of FIG. 9, described above.

Note that for a multi-dimensional link selection, the algorithm described in reference to FIG. 10 may be repeated multiple times for multiple performance metrics to develop/compose a set of candidate links.

In some instances, inputs into a multi-dimensional link selection algorithm may include various performance metrics collected at different protocol layers and/or from an application layer. In some instances, the multi-dimensional link selection algorithm may adjust the inputs from the different protocol layers/application layer in order to compare inputs at a common layer. In other words, inputs may be adjusted such that QoE, QoS, and/or QoP are compared based on a common layer. For example, a performance metric such as throughput may be defined differently according to protocol overheads, direction (e.g., uplink or downlink), and/or a link type. For QoE, throughput may be characterized as application layer effective throughput whereas for QoS, throughput is often characterized at a PDCP/MAC layer and L1/PHY layer for QoP. Thus, to compare QoE, QoS, and QoP associated with the metric of throughput, a factor of layer-specific protocol overheads may be considered.

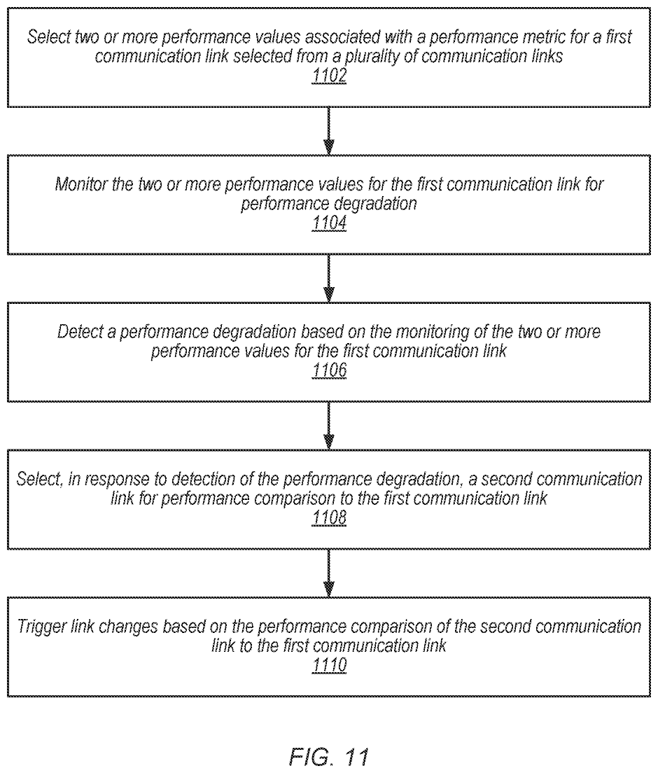

FIG. 11 illustrates a block diagram of an example of a method for link selection, according to some embodiments. The method shown in FIG. 11 may be used in conjunction with any of the systems, methods, or devices shown in the Figures, among other devices. In various embodiments, some of the elements shown may be performed concurrently, in a different order than shown, or may be omitted. Additional elements may also be performed as desired. As shown, this method may flow as follows.

At 1102, a UE, such as UE 106, may determine, select, and/or derive two or more performance values for a first communication link selected from a plurality of communication links. The two or more performance values may be associated with a performance metric. The performance metric may be configured for monitoring. In other words, the first communication link may be selected for performance monitoring and the performance metric may be selected to gauge performance of the first communication link. The two or more performance values may include an agreed value for the performance metric for the first communication link (e.g., a QoS value for the performance metric for the first communication link), a measured value for the performance metric for the first communication link (e.g., a QoE value for the performance metric for the first communication link), and/or a predicted value for the performance metric for the first communication link (e.g., a QoP value for the performance metric for the first communication link. The agreed value (e.g., QoS value) may be configured based on an agreement between the UE and a network entity and/or configured at an application layer of the UE. The measured value (e.g., QoE value) may be based, at least in part, on measurements of the performance metric on the first communication link. The predicted value (e.g., QoP value) may be predicted based on a historical database associated with the performance metric, historical measurements of the performance metric, UE status and/or network status. In some instances, the performance metric may be at least one of (and/or one or more of) average throughput, maximum queuing latency, average queue size, packet loss rate, channel quality, video frame loss rate, video stall statistics, percentage of allocated radio resources in time-frequency, percentage of channel occupancy, bandwidth, and/or time-frequency resource reservation. Note that the first communication link may be in an uplink (e.g., UE to network) direction, a downlink (e.g., network to UE) direction, and/or a sidelink (e.g., UE to UE) direction.

At 1104, the UE may monitor the two or more performance values for the first communication link for performance degradation.

At 1106, the UE may detect a performance degradation based on the monitoring of the two or more performance values for the first communication link. In some instances, to detect performance degradation, the UE may compare at least two of an agreed value for the performance metric, a measured value for the performance metric, and/or a predicted value for the performance metric for the first communication link. Further, the UE may determine, based on the comparison, that performance on the first communication link is degrading. Additionally, to determine that performance on the first communication link is degrading, the UE may determine that the predicted value for the performance metric is less than the measured value for the performance metric, that the measured value for the performance metric is less than the agreed value for the performance metric, and/or that the predicted value for the performance metric is less than the agreed value for the performance metric. In some instances, one or more of the agreed value, measured value, or predicted value is weighted. In some instances, one or more of the agreed value, measured value, or predicted value may be corrected and/or adjusted based on an associated protocol layer. In other words, when one of the agreed value, measured value, or predicted value is associated with a different protocol layer than an other of the agreed value, measured value, or predicted value, values may be adjusted such that the comparison takes into account the different protocol layers associated with the values.

At 1108, the UE may select, in response to detecting a performance degradation, a second communication link for performance comparison to the first communication link. In some instances, to select, in response to detecting a performance degradation, the second communication link for performance comparison to the first communication link, the UE may derive a set of candidate links for performance comparison to the first communication link, sort the set of candidate links based on a respective value of the performance metric for each candidate link, and select a best performing candidate link based on the sorting. In such instances, the second communication link may be the best performing candidate link. In some instances, the respective value of the performance metric for a candidate link may be at least one of an agreed value for the performance metric for the candidate link, a measured value for the performance metric for the candidate link, and/or a predicted value for the performance metric for the candidate link.

At 1110, the UE may trigger link changes based on the performance comparison of the second communication link to the first communication link. In some instances, to perform the performance comparison of the second communication link to the first communication link, the UE may compare an agreed value for the performance metric for the second communication link to a measured value for the performance metric for the first communication link and compare a predicted value for the performance metric for the second communication link to the measured value for the performance metric for the first communication link. Further, when the agreed value for the performance metric for the second communication link exceeds the measured value for the performance metric for the first communication link and the predicted value for the performance metric for the second communication link exceeds the measured value for the performance metric for the first communication link, The UE may trigger a switch to the second communication link. Additionally, when the agreed value for the performance metric for the second communication link does not exceed the measured value for the performance metric for the first communication link but the predicted value for the performance metric for the second communication link exceeds the measured value for the performance metric for the first communication link, the UE may trigger an addition of the second communication link as an additional component carrier. In addition, when the agreed value for the performance metric for the second communication link does not exceed the measured value for the performance metric for the first communication link but the predicted value for the performance metric for the second communication link exceeds the measured value for the performance metric for the first communication link, the UE may trigger an addition of the second communication link as a secondary cell group. In some instances, to trigger link changes based on the performance comparison of the second communication link to the first communication link, the UE may switch to the second communication link via over-the-air signaling with a network, add the second communication link as an additional radio access technology via over-the-air signaling with the network, add the second communication link as an additional channel via over-the-air signaling with the network, add the second communication link as an additional radio bearer via over-the-air signaling with the network, add the second communication link as an additional component carrier via over-the-air signaling with the network, and/or add the second communication link as a secondary cell group via over-the-air signaling with the network.

In some instances, the performance metric may be a first performance metric of a plurality of performance metrics. In such instances, for each of the plurality of performance metrics, the UE may determine two or more performance values associated with a respective performance metric of the plurality of performance metrics for the first communication link, monitor the two or more performance values for the first communication link for performance degradation, and select, in response to detecting a performance degradation, an other communication link for performance comparison to the first communication link. The repetition may result in a set of candidate communication links. Further, to trigger link changes based on the performance comparison of the second communication link to the first communication link, the UE may trigger link changes based on the performance comparison of the set of candidate communication links to the first communication link. Further, to trigger link changes based on the performance comparison of the set of candidate communication links to the first communication link, the UE may derive a best performing communication link from the set of candidate communication links based on the performance comparison and switch to the best performing communication link via over-the-air signaling with a network or add the best performing communication as an additional component carrier or a secondary cell group via over-the-air signaling with the network.

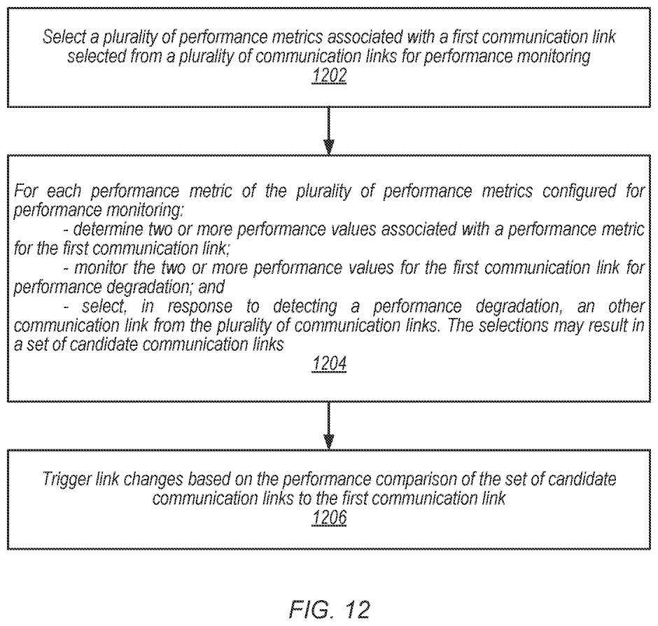

FIG. 12 illustrates a block diagram of another example of a method for link selection, according to some embodiments. The method shown in FIG. 12 may be used in conjunction with any of the systems, methods, or devices shown in the Figures, among other devices. In various embodiments, some of the elements shown may be performed concurrently, in a different order than shown, or may be omitted. Additional elements may also be performed as desired. As shown, this method may flow as follows.

At 1202, a UE, such as UE 106, may select a plurality of performance metrics associated with a first communication link selected from a plurality of communication links for performance monitoring. In some instances, the performance metric may be at least one of (and/or one or more of) average throughput, maximum queuing latency, average queue size, packet loss rate, channel quality, video frame loss rate, video stall statistics, percentage of allocated radio resources in time-frequency, percentage of channel occupancy, bandwidth, and/or time-frequency resource reservation. Note that the first communication link may be in an uplink (e.g., UE to network) direction, a downlink (e.g., network to UE) direction, and/or a sidelink (e.g., UE to UE) direction.

At 1204, for each performance metric of the plurality of performance metrics configured for performance monitoring, the UE may determine two or more performance values associated with a performance metric for the first communication link, monitor the two or more performance values for the first communication link for performance degradation, and select, in response to detecting a performance degradation, an other communication link from the plurality of communication links. The selections may result in a set of candidate communication links.

The two or more performance values may be associated with a performance metric configured for monitoring. In other words, the first communication link may be selected for performance monitoring and the performance metric may be selected to gauge performance of the first communication link. The two or more performance values may include an agreed value for the performance metric for the first communication link (e.g., a QoS value for the performance metric for the first communication link), a measured value for the performance metric for the first communication link (e.g., a QoE value for the performance metric for the first communication link), and/or a predicted value for the performance metric for the first communication link (e.g., a QoP value for the performance metric for the first communication link. The agreed value (e.g., QoS value) may be configured based on an agreement between the UE and a network entity and/or configured at an application layer of the UE. The measured value (e.g., QoE value) may be based, at least in part, on measurements of the performance metric on the first communication link. The predicted value (e.g., QoP value) may be predicted based on a historical database associated with the performance metric, historical measurements of the performance metric, UE status and/or network status.

In some instances, to detect performance degradation, the UE may compare at least two of an agreed value for the performance metric, a measured value for the performance metric, and/or a predicted value for the performance metric for the first communication link. Further, the UE may determine, based on the comparison, that performance on the first communication link is degrading. Additionally, to determine that performance on the first communication link is degrading, the UE may determine that the predicted value for the performance metric is less than the measured value for the performance metric, that the measured value for the performance metric is less than the agreed value for the performance metric, and/or that the predicted value for the performance metric is less than the agreed value for the performance metric. In some instances, one or more of the agreed value, measured value, or predicted value is weighted. In some instances, one or more of the agreed value, measured value, or predicted value may be corrected and/or adjusted based on an associated protocol layer. In other words, when one of the agreed value, measured value, or predicted value is associated with a different protocol layer than an other of the agreed value, measured value, or predicted value, values may be adjusted such that the comparison takes into account the different protocol layers associated with the values.

In some instances, to select, in response to detecting a performance degradation, the other communication link for performance comparison to the first communication link, the UE may derive a set of candidate links for performance comparison to the first communication link, sort the set of candidate links based on a respective value of the performance metric for each candidate link, and select a best performing candidate link based on the sorting. In such instances, the other communication link may be the best performing candidate link according to the performance metric. In some instances, the respective value of the performance metric for a candidate link may be at least one of an agreed value for the performance metric for the candidate link, a measured value for the performance metric for the candidate link, and/or a predicted value for the performance metric for the candidate link.

At 1206, the UE may trigger link changes based on the performance comparison of the set of candidate communication links to the first communication link. In some instances, to trigger link changes based on the performance comparison of the set of candidate communication links to the first communication link, the UE may derive a best performing communication link from the set of candidate communication links based on the performance comparison and switch to the best performing communication link via over-the-air signaling with a network. In some instances, to trigger link changes based on the performance comparison of the set of candidate communication links to the first communication link, the UE may derive a best performing communication link from the set of candidate communication links based on the performance comparison and or add the best performing communication as an additional component carrier or a secondary cell group via over-the-air signaling with a network.

In some instances, to compare performance of the set of candidate communication links to the first communication link, the UE may derive a best performing communication link from the set of candidate communication links based on the performance comparison, compare an agreed value for the performance metric for the best performing communication link to a measured value for the performance metric for the first communication link and compare a predicted value for the performance metric for the best performing communication link to the measured value for the performance metric for the first communication link. Further, when the agreed value for the performance metric for the best performing communication link exceeds the measured value for the performance metric for the first communication link and the predicted value for the performance metric for the best performing communication link exceeds the measured value for the performance metric for the first communication link, the UE may trigger a switch to the best performing communication link. Additionally, when the agreed value for the performance metric for the best performing communication link does not exceed the measured value for the performance metric for the first communication link but the predicted value for the performance metric for the best performing communication link exceeds the measured value for the performance metric for the first communication link, the UE may trigger addition of the best performing communication link as an additional component carrier. In addition, when the agreed value for the performance metric for the best performing communication link does not exceed the measured value for the performance metric for the first communication link but the predicted value for the performance metric for the best performing communication link exceeds the measured value for the performance metric for the first communication link, the UE may trigger addition of the best performing communication link as a secondary cell group.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for communication link selection at a user equipment device (UE), comprising:
determining two or more performance values for a first communication link selected from a plurality of communication links, wherein the two or more performance values are associated with a performance metric;
monitoring the two or more performance values for the first communication link for performance degradation;
detecting a performance degradation based on the monitoring of the two or more performance values for the first communication link;
selecting, in response to detection of the performance degradation, a second communication link for performance comparison to the first communication link; and
triggering link changes based on the performance comparison of the second communication link to the first communication link.

2. The method of claim 1,
wherein the two or more performance values comprise two or more of:
an agreed value for the performance metric for the first communication link;
a measured value for the performance metric for the first communication link; or
a predicted value for the performance metric for the first communication link.

3. The method of claim 2,
wherein the agreed value for the performance metric for the first communication link comprises a quality of service (QOS) value;
wherein the measured value for the performance metric for the first communication link comprises a quality of experience (QoE) value; and
wherein the predicted value for the performance metric for the first communication link a predicted quality of experience (QoP) value.

4. The method of claim 1,
wherein the two or more performance values comprise at least a quality of service (QoS) value associated with the performance metric, and wherein the QoS value is configured based on an agreement between the UE and a network entity or configured at an application layer of the UE.

5. The method of claim 1,
wherein the two or more performance values comprise at least a quality of a quality of experience (QoE) value associated with the performance metric, and wherein the QoE value is based, at least in part, on measurements of the performance metric on the first communication link.

6. The method of claim 1,
wherein the two or more performance values comprises a predicted quality of experience (QoP) value associated with the performance metric, wherein the QoP value is predicted based on at least one of:
a historical database associated with the performance metric;
historical measurements of the performance metric;
UE status; or
network status.

7. The method of claim 1,
wherein the performance metric comprises at least one of:
average throughput;
maximum queuing latency;
average queue size;
packet loss rate;
channel quality;
video frame loss rate;
video stall statistics;
percentage of allocated radio resources in time-frequency;
percentage of channel occupancy;
bandwidth; or
time-frequency resource reservation.

8. The method of claim 1,
wherein triggering link changes based on the performance comparison of the second communication link to the first communication link comprises at least one of:
switching to the second communication link via over-the-air signaling with a network;
adding the second communication link as an additional radio access technology via over-the-air signaling with the network;
adding the second communication link as an additional channel via over-the-air signaling with the network;
adding the second communication link as an additional radio bearer via over-the-air signaling with the network;
adding the second communication link as an additional component carrier via over-the-air signaling with the network; or
adding the second communication link as a secondary cell group via over-the-air signaling with the network.

9. A user equipment device (UE), comprising:
at least one antenna;
at least one radio in communication with the at least one antenna and configured to communicate according to at least one radio access technology (RAT); and
one or more processors in communication with the at least one radio and configured to cause the UE to:
determine two or more performance values for a first communication link selected from a plurality of communication links, wherein the two or more performance values are associated with a performance metric;
monitor the two or more performance values for the first communication link for performance degradation;
detect a performance degradation based on the monitoring of the two or more performance values for the first communication link;
select, in response to the detection of the performance degradation, a second communication link for performance comparison to the first communication link; and
trigger link changes based on the performance comparison of the second communication link to the first communication link.

10. The UE of claim 9,
wherein, to detect the performance degradation, the one or more processors are configured to cause the UE to:
compare at least two of an agreed value for the performance metric, a measured value for the performance metric, or a predicted value for the performance metric for the first communication link; and
determine, based on the comparing, that performance on the first communication link is degrading.

11. The UE of claim 10,
wherein, to determine that performance on the first communication link is degrading, the one or more processors are configured to cause the UE to:
determine that the predicted value for the performance metric is less than the measured value for the performance metric, that the measured value for the performance metric is less than the agreed value for the performance metric, or that the predicted value for the performance metric is less than the agreed value for the performance metric.

12. The UE of claim 10,
wherein one or more of the agreed value, measured value, or predicted value is weighted.

13. The UE of claim 9,
wherein, to perform a comparison of the second communication link to the first communication link, the one or more processors are configured to cause the UE to:
compare an agreed value for the performance metric for the second communication link to a measured value for the performance metric for the first communication link; and
compare a predicted value for the performance metric for the second communication link to the measured value for the performance metric for the first communication link.

14. The UE of claim 13,
wherein, when the agreed value for the performance metric for the second communication link exceeds the measured value for the performance metric for the first communication link and the predicted value for the performance metric for the second communication link exceeds the measured value for the performance metric for the first communication link, the one or more processors are configured to cause the UE to switch to the second communication link; and
wherein, when the agreed value for the performance metric for the second communication link does not exceed the measured value for the performance metric for the first communication link but the predicted value for the performance metric for the second communication link exceeds the measured value for the performance metric for the first communication link, the one or more processors are configured to cause the UE to add the second communication link as an additional component carrier or a secondary cell group.

15. The UE of claim 9,
wherein the performance metric is a first performance metric of a plurality of performance metrics, and wherein, for each of the plurality of performance metrics, the one or more processors are configured to cause the UE to:
determine two or more performance values associated with a respective performance metric of the plurality of performance metrics for the first communication link;
monitor the two or more performance values for the first communication link for performance degradation; and
select, in response to detecting a performance degradation, an other communication link for performance comparison to the first communication link, wherein the selecting results in a set of candidate communication links.

16. The UE of claim 15,
wherein, to trigger link changes based on the performance comparison of the second communication link to the first communication link, the one or more processors are configured to cause the UE to:
trigger link changes based on the performance comparison of the set of candidate communication links to the first communication link.

17. The UE of claim 16,
wherein, to trigger link changes based on the performance comparison of the set of candidate communication links to the first communication link, the one or more processors are configured to cause the UE to:
derive a best performing communication link from the set of candidate communication links based on the performance comparison; and
switch to the best performing communication link via over-the-air signaling with a network or add the best performing communication as an additional component carrier or a secondary cell group via over-the-air signaling with the network.

18. An apparatus, comprising:
a memory; and
at least one processor in communication with the memory and configured to:
select two or more performance values associated with a performance metric for a first communication link selected from a plurality of communication links;
monitor the two or more performance values for the first communication link for performance degradation;
detect a performance degradation based on the monitoring of the two or more performance values for the first communication link;
select, in response to the detection of the performance degradation, a second communication link for performance comparison to the first communication link; and
trigger link changes based on the performance comparison of the second communication link to the first communication link.

19. The apparatus of claim 18,
wherein, to select, in response to detecting a performance degradation, the second communication link for performance comparison to the first communication link, the at least one processor is configured to:
derive a set of candidate links for performance comparison to the first communication link;
sort the set of candidate links based on a respective value of the performance metric for each candidate link; and
select a best performing candidate link based on the sorting, wherein the second communication link comprises the best performing candidate link.

20. The apparatus of claim 19,
wherein the respective value of the performance metric for a candidate link comprises at least one of:
an agreed value for the performance metric for the candidate link;
a measured value for the performance metric for the candidate link; or
a predicted value for the performance metric for the candidate link.
